(19) United States
(12) Patent Application Publication
(10) Pub. No.: US 2015/0200814 A1
(43) Pub. Date: Jul. 16, 2015

(54) NETWORK EMULATOR, NETWORK SYSTEM HAVING THE SAME AND METHOD FOR PROVIDING A SIMULATED MOBILE COMMUNICATION NETWORK USING THE SAME

(71) Applicant: NHN Entertainment Corporation, Seongnam-si (KR)

(72) Inventors: Dong-Min KANG, Seongnam-si (KR); II-Hwan KIM, Seongnam-si (KR)

(21) Appl. No.: 14/597,706

(22) Filed: Jan. 15, 2015

(30) Foreign Application Priority Data
Jan. 15, 2014 (KR) 10-2014-0004982

(51) Int. Cl. H04L 12/24; H04W 84/12

(52) U.S. Cl. CPC H04L 41/145; H04W 84/12

(57) ABSTRACT

A network emulator, a network system having the same, and a method for providing a simulated mobile communication network using the same is disclosed. The network emulator connects an external device and at least one wireless terminal and transfers data, stores data transfer environment for at least a target mobile communication network, and changes a data transfer environment to one of a first simulated mobile communication network transfer environment based on data transferred from the external device or a second simulated mobile communication network transfer environment based on data transferred from the mobile device.

### CROSS REFERENCE TO RELATED APPLICATIONS

This application claims priority from and the benefit of Korean Patent Application No. 10-2014-0004982, filed on Jan. 15, 2014, which is hereby incorporated by reference for all purposes as if fully set forth herein.

### BACKGROUND

1. Field

Exemplary embodiments of the present invention relate to a network emulator, a network system having the same, and a method for providing a simulated mobile communication network using the same. More specifically, exemplary embodiments of the present invention relate to a network emulator which can create a simulated mobile communication network similar to a target mobile communication network, a network system having the same, and a method for forming a simulated mobile communication network using the same.

2. Discussion of the Background

Data transfer rate has gradually increased due to progress of communication technology where various applications, which provide access to services by connecting the mobile communication network using a mobile device such as a smartphone, have been developed.

However, mobile communication networks may have different data transfer environment, for example, data transfer rate, because the mobile communication network varies depending on, for example, geographical locations (e.g. countries), and mobile communication service providers. Therefore, the same application may not work well in a mobile communication network having a poor data transfer environment.

Recently, many application developers have been trying to develop applications that can work well under a poor data transfer environment. Application developers need to test applications using a network simulation equipment that can simulate a transfer environment similar to the poor data transfer environment.

However, because the conventional network simulation equipment can only be used for very limited devices, tests for various mobile network communication environments could not be carried out simultaneously by multiple users.

The above information disclosed in this background section is only for enhancement of understanding of the background of the invention and therefore it may contain information that does not form any part of the prior art nor what the prior art may suggest to a person of ordinary skill in the art.

### SUMMARY

A network emulator according to an exemplary embodiment of the present invention connects an external device and at least one mobile device to transfer data, stores at least one data transfer environment for at least one target mobile communication network; and changes a data transfer environment to one of a first simulated mobile communication network transfer environment based on data transferred from the external device or a second simulated mobile communication network transfer environment based on data transferred from the mobile device.

Additional aspects will be set forth in the detailed description which follows, and, in part, will be apparent from the disclosure, or may be learned by practice of the inventive concept.

A network system according to an exemplary embodiment of the present invention comprises: a network relay providing a connection with external internet or forming an internal network, at least one mobile device, and a network emulator connecting an external device and at least one mobile device to transfer data and storing data transfer environment for at least a target mobile communication.

A method providing a simulated mobile communication network according to an embodiment of the present invention using a network emulator connecting an external device and at least one mobile device and transferring data comprises determining a simulated mobile communication network transfer environment data transfer environment for at least a target mobile communication network; and changing a data transfer environment to one of a first simulated mobile communication network transfer environment based on data transferred from the external device or a second simulated mobile communication network transfer environment based on data transferred from the mobile device.

The foregoing general description and the following detailed description are exemplary and explanatory and are intended to provide further explanation of the claimed subject matter.

### BRIEF DESCRIPTION OF THE DRAWING

The accompanying drawings, which are included to provide a further understanding of the disclosure and are incorporated in and constitute a part of this specification, illustrate exemplary embodiments of the disclosure, and together with the description serve to explain the principles of the disclosure.

FIG. 1 is a diagram for explaining a conventional internal network.

FIG. 2 is a schematic diagram illustrating a network system according to an exemplary embodiment of the present invention.

FIG. 3 illustrates mobile device accessing internet in an internal network to exchange data according to exemplary embodiments of the present invention.

FIG. 4 illustrates mobile device accessing internet in a network system of FIG. 2 to exchange data according to exemplary embodiments of the present invention.

FIG. 5 illustrates a process for determining a simulated mobile communication network transfer environment by selecting one of target mobile communication network transfer environments stored in a network emulator of according to exemplary embodiments of the present invention.

FIG. 6 illustrates a target mobile communication network transfer environment according to exemplary embodiments of the present invention.

### DETAILED DESCRIPTION OF THE ILLUSTRATIVE EMBODIMENTS

The present disclosure is described more fully hereinafter with reference to the accompanying drawings, in which embodiments of the present disclosure are shown. The present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. In the drawings, the sizes and relative sizes of layers and regions may be exaggerated for clarity.

It will be understood that, although the terms first, second, third etc. may be used herein to describe various elements, components, regions, layers and/or sections, these elements, components, and/or sections should not be limited by these terms. These terms are only used to distinguish one element, component, region, layer or section from another region, layer or section. Thus, a first element, component, or section discussed below could be termed a second element, component, or section without departing from the teachings of the present disclosure.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Hereinafter, with reference to the drawings, preferred embodiments of the present disclosure will be described in detail.

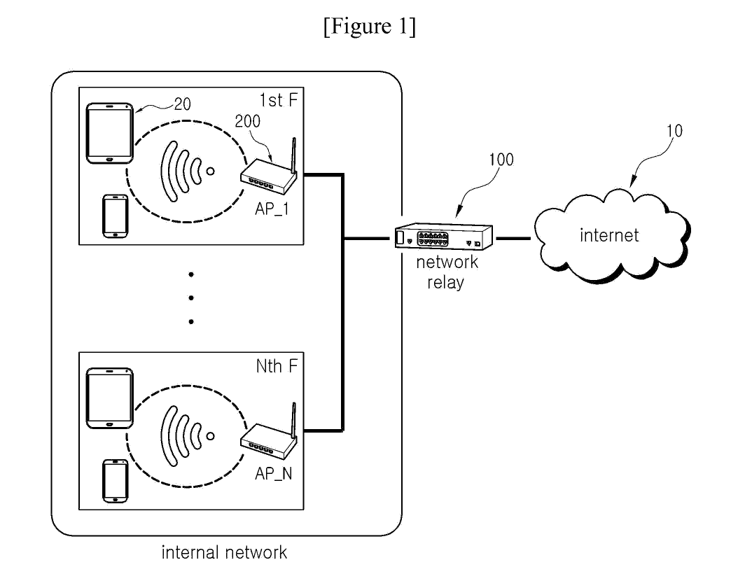

FIG. 1 is a diagram illustrating a conventional internal network.

Referring to FIG. 1, a conventional internal network may include a network relay 110 and at least one wireless router 210, where the network relay 100 may connect the wireless router 210 to an internet 11.

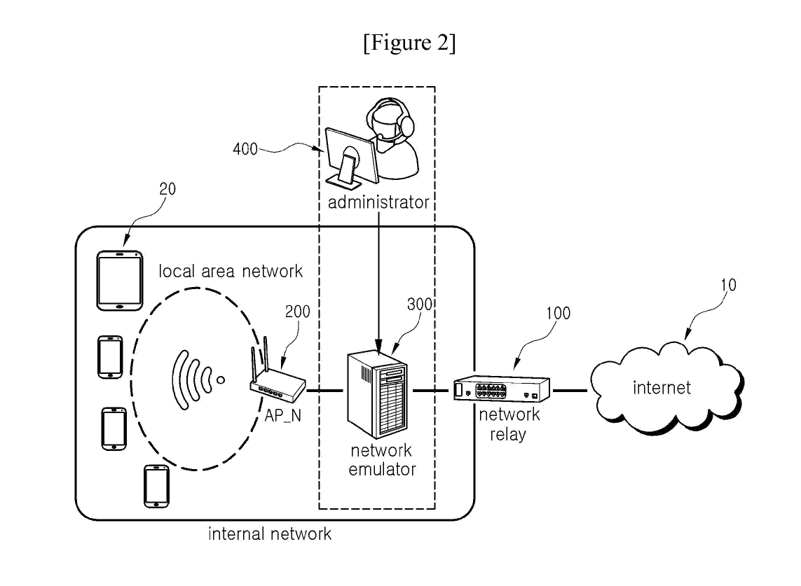

FIG. 2 is a schematic diagram illustrating a network system according to an exemplary embodiment of the present invention.

Referring to FIG. 2, a network system according to an exemplary embodiment of the present invention may include a network relay 100, and at least one of a wireless router 200 and a network emulator 300. The network system of FIG. 2 includes the network emulator 300 in an internal network.

The network relay 100 may relay a connection to an external internet 10, or may form an internal network. For example, the network relay 100 may be one of a network switch, a network router, a network hub, and a router.

The wireless router 200 may form a local area communication network, e.g., Wi-Fi, to exchange data with at least a mobile device 20. More specifically, the wireless router 200 may be equipped at specific locations, e.g., on each floors of a building, to form a local area communication network, and may exchange data with a plurality of mobile devices 20 connected to the local area communication network.

The network emulator 300 connects the network relay 100 and the wireless router 200 to transfer data. Also, the network emulator 300 may store, in an internal memory, at least data transfer environments of target mobile communication networks.

According to an exemplary embodiment of the present invention, the network system may further include an administrator terminal 400, which may be connected to the network emulator 300 by wire or wirelessly to manage the network emulator 300.

The administrator terminal 400 may access the network emulator 300 to delete or modify a pre-stored data transfer environment of a target mobile communication network, or to add a new data transfer environment of a target mobile communication network.

As explained above, the network emulator 300 may be wirelessly connected to the mobile device 20 through the wireless router 200, but is not limited thereto. The network emulator 300 may be connected to the mobile device 20, for example, directly or through wire. The network emulator 300 may include, for example, a wireless or wire socket directly connectable to the mobile device 20, in which case, the wireless router 200 may be omitted.

In addition, as noted above, the network emulator 300 may be connected to the external internet 10 or other network access devices through the network relay 100, but is not limited thereto, and the network emulator 300 may, for example, be connected to the external internet 10 or other network access devices directly. The network emulator 300 may function as the network relay 100, in which case, the network relay 100 may be omitted.

In the following paragraphs, an exemplary method to form a simulated mobile communication network reproducing a data transfer environment of a target mobile communication network, using the above wireless network system, is described in more detail.

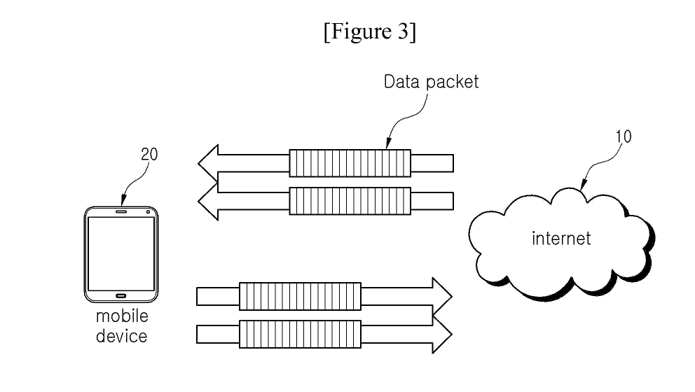

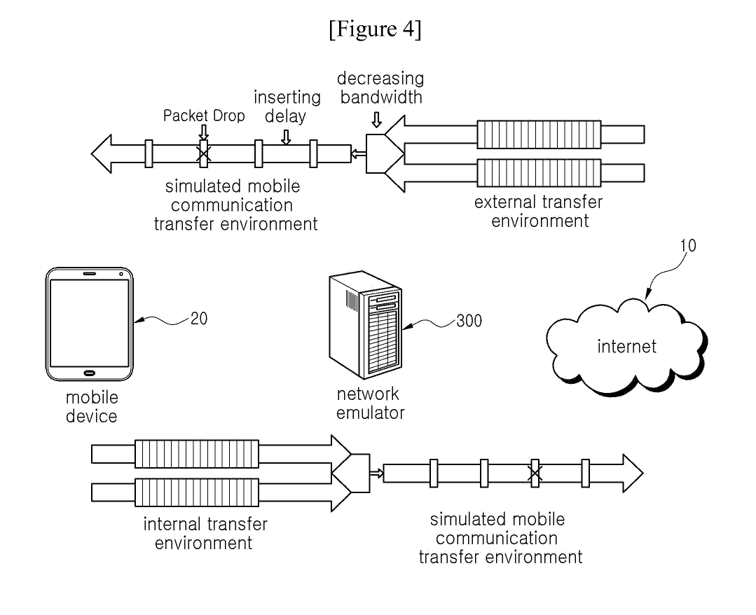

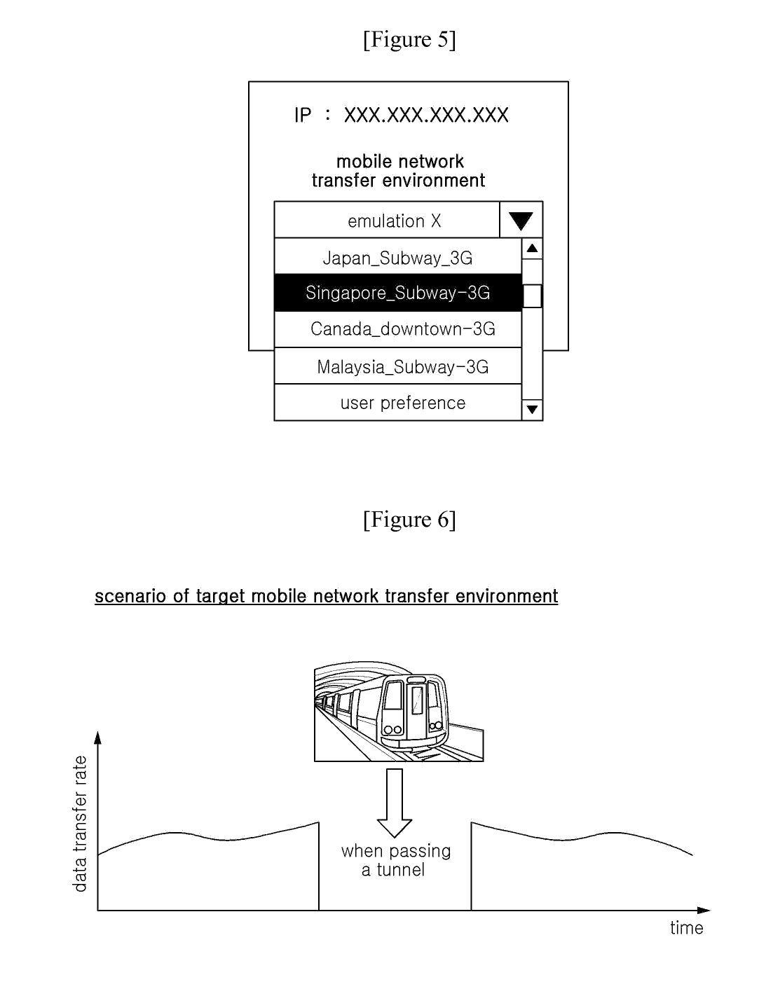

FIG. 3 illustrates an exemplary embodiment of a mobile device which accesses internet in an internal network to exchange data, FIG. 4 illustrates an exemplary embodiment of a mobile device which accesses internet in the network system (e.g., network system of FIG. 2) to exchange data, FIG. 5 illustrates an exemplary process for determining a simulated mobile communication network transfer environment by selecting one of target mobile communication network transfer environments stored in a network emulator (e.g., network emulator of FIG. 2), and FIG. 6 illustrates an exemplary scenario for one of the target mobile communication network transfer environments. Although the mobile device of FIG. 3 and the process of FIG. 5 are described with respect to network system of FIG. 2, aspects of the invention are not limited thereto.

Referring to FIGS. 3, 4 and 5, first, one of data transfer environment of target mobile communication network or target mobile communication transfer environment, which may be stored in the network emulator 300, may be selected to determine a mobile communication transfer environment to be simulated. More specifically, the mobile device 20 may select one of a plurality of target mobile communication network transfer environments, after accessing the network emulator 300, to determine the simulated mobile communication transfer environment.

Then, a data transfer environment under which data may be transferred from the internet 10 or a digital device (not shown) to the network emulator 300 through the network relay 100 may be changed to the simulated mobile communication transfer environment, and may be provided for the mobile device 20.

In addition, it may be possible to change a data transfer environment under which data is transferred from the mobile device 20 to the network emulator 300, or an internal transfer environment, through the wireless router 200 into the simulated mobile communication transfer environment which is provided for the internet or a digital device (not shown) in the internal network through the network relay 200.

According to an exemplary embodiment of the present invention, one or more of the target mobile communication network transfer environments may be an environment where data transfer rate varies with time according to a scenario. More specifically, the target mobile communication network transfer environments' data transfer rate may vary with time according to one or more of scenarios. For example, one or more of the target mobile communication network transfer environments may be a data transfer environment that can be experienced downtown or in a subway of a foreign mobile communication networks.

Herein, the scenario may be written, using at least one of modification of bandwidth for data transfer, insertion of delay into data, and drop of data packet, but aspects of the invention are not limited thereto.

For example, the scenario may be based on a data transfer rate data obtained by measuring changes of data transfer rate with time in a downtown area or on a subway of a foreign country, or based on a hypothetical scenario for a foreign mobile communication network. The scenario may include variation of bandwidth, degree of delaying time, data packet drop interval, and the like, in order to reproduce the target mobile communication network transfer environment similar to the data transfer rate data or the hypothetical scenario. For example, the scenario may include an environment where a user passes through a tunnel in a subway train, where data packet drop may occur at various intervals.

The target mobile communication network transfer environments stored in the network emulator 300 may be deleted, modified, or added by the administrator. For example, an administrator having access authority may access the network emulator 300 by the administrator terminal 400 to delete or modify a pre-stored data transfer environment of a target mobile communication network, or to add a new data transfer environment of a target mobile communication network.

As described above, according to exemplary embodiments of the present invention, it may be possible to determine a simulated mobile communication network transfer environment by selecting one of at least one target mobile communication network transfer environment stored in the network emulator 300, to change a data transfer environment of data transferred to the network emulator 300 through the network relay 100 into the simulated mobile communication transfer environment to provide for the mobile device 20, or to change a data transfer environment of data transferred to the network emulator 300 through the wireless router 200 into the simulated mobile communication transfer environment provided for the network relay 100.

Therefore, developers who wish to develop an application for foreign mobile communication network may select a data transfer environment identical or similar to the transfer environment of the desired foreign mobile communication network to test a new application program. More specifically, the more users can experience various transfer environment of various simulated mobile communication networks, which may simulate a real mobile communication network transfer environment, using their own mobile device.

In addition, the wireless network system can help a mobile device in the wireless network system communicate or exchange data with other mobile device in a foreign mobile communication network under a similar transfer environment by forming an identical or similar to the foreign mobile communication network.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A network emulator configured to:
connect an external device and at least one mobile device to transfer data;
store at least one data transfer environment for at least one target mobile communication network; and
change a data transfer environment to one of a first simulated mobile communication network transfer environment for data transferred from the external device or a second simulated mobile communication network transfer environment for data transferred from the mobile device,
wherein the first and second simulated mobile communication network transfer environment is selected from the at least one data transfer environment.

2. The network emulator of claim 1, wherein data transfer rate of the target mobile communication transfer environment varies with time according to a scenario.

3. The network emulator of claim 2, wherein the scenario includes at least one of modification of bandwidth for data transfer, insertion of delay into data, and drop of data packet.

4. The network emulator of claim 1, wherein the simulated mobile communication network transfer environment is determined based on selection of one of the first or second target mobile communication transfer environment.

5. The network emulator of claim 1, wherein at least one of the first and second target mobile communication network transfer environments is deleted or changed, or
a third target mobile communication network transfer environment is added.

6. The network emulator of claim 1, wherein the mobile device is wirelessly connected to the network emulator.

7. The network emulator of claim 1, wherein the mobile device is directly connected to the network emulator.

8. The network emulator of claim 1, wherein the external device comprises a network relay configured to provide a connection with external internet or to form an internal network.

9. The network emulator of claim 1, wherein the external device is configured to provide a connection to an external internet.

10. A network system comprising:
a network relay configured to provide a connection with external internet or to form an internal network; and
a network emulator configured to connect an external device and at least one mobile device to transfer data, and to store at least one data transfer environment for at least one target mobile communication network,
wherein the network emulator is configured to change one of a first simulated mobile communication network transfer environment for data transferred from the external device or a second simulated mobile communication network transfer environment for data transferred from the mobile device, wherein the first and second simulated mobile communication network transfer environment is selected from the at least one data transfer environment.

11. The network system of claim 10, wherein data transfer rate of the target mobile communication transfer environment varies with time according to a scenario.

12. The network system of claim 11, wherein the scenario comprises at least one of modification of bandwidth for data transfer, insertion of delay into data, and drop of data packet.

13. The network system of claim 10, wherein the simulated mobile communication network transfer environment is determined based on selection of one of the first or second target mobile communication transfer environment.

14. The network system of claim 10, wherein at least one of the first and second target mobile communication network transfer environments is deleted or changed, or
a third target mobile communication network transfer environment is added.

15. The network system of claim 10, further comprising at least one wireless router to connect the network emulator and the mobile device, and to form a local network.

16. The network system of claim 10, wherein the mobile device is directly connected to the network emulator.

17. A method providing a simulated mobile communication network using a network emulator, the network emulator connecting an external device and at least one mobile device to transfer data, comprising:
determining a simulated mobile communication network transfer environment from data transfer environments for at least one target mobile communication network;
changing a data transfer environment to the simulated mobile communication network transfer environment for data transferred from the external device; and
changing a data transfer environment to the simulated mobile communication network transfer environment for data transferred from the mobile device.

18. A method of claim 17, wherein the simulated mobile communication network transfer environment is determined based on selection of one of the data transfer environments.

19. A method of claim 17, wherein at least one of the first and second target mobile communication network transfer environment is deleted or changed, or
a third target mobile communication network transfer environment is added.

20. A method of claim 17, wherein the external device comprises a network relay configured to provide a connection with external internet or to form an internal network.
